(19) United States
(12) Patent Application Publication
(10) Pub. No.: US 2026/0313027 A1
(43) Pub. Date: Oct. 8, 2026

(54) MEASURING SYSTEM WITH ONE OR MORE FIELD DEVICES

(71) Applicant: Endress+Hauser Process Solutions AG, Reinach (CH)

(72) Inventors: Robert Lichtenheldt, Leipzig (DE); Alexander Meinhardt, Lörrach (DE); Dietmar Saecker, Nesselwang (DE); Alexander Sattler, Rust (DE); Elke Schmidt, Bad Säckingen (DE); Benjamin Schwenter, Ettingen (CH); Peter Wazinski, Freiburg (DE); Steffen Ziegler, Schopfheim (DE); Jana Eichhorn, Herrenberg (DE)

(21) Appl. No.: 19/483,042

(22) PCT Filed: Mar. 19, 2024
(86) PCT No.: PCT/EP2024/057279

§ 371 Date: Nov. 10, 2025

(30) Foreign Application Priority Data
May 8, 2023 (DE) 10 2023 112 005.0

(51) Int. Cl. H04L 67/12; G05B 19/042

(52) U.S. Cl. CPC H04L 67/12; G05B 19/042

(57) ABSTRACT

A system with field devices includes an adapter for each field device, and a unit to which each field device can be connected. Each adapter comprises a communication unit to which an adapter interface, a radio interface and a connection interface are connected. The unit comprises a communication unit to which a radio interface and connection interfaces are connected. Each field device can be connected to the unit both via a radio connection between the radio interface of the unit and the radio interface of the adapter connected to the field device in question, and via a connection link between a connection interface of the unit and the connection interface of the adapter connected to the field device in question. The unit a gateway module which communicates according to a module-specific communication protocol, and via which the unit can be connected to a higher-level unit.

The invention relates to a measuring system with one or more field devices that can be connected to a higher-level unit for measuring variables to be measured with the measuring system.

Field devices for measuring variables are used, for example, in measurement technology, as well as in process and automation technology in a wide range of different applications, such as applications in the chemical industry, the food industry, and also in water and wastewater treatment.

Examples of applications comprise, for example, manufacturing, processing, and/or treatment plants in which field devices are used to measure parameters relevant to the operation of the plant. These field devices are usually connected to a higher-level unit, such as a control system or a process guidance system, which monitors the operation of the plant and/or monitors, controls, and/or regulates processes to be carried out at the measuring point based on measured values of the measured variables. These applications regularly require a large number of different field devices. The field devices comprise, for example, measuring devices and/or sensors, such as pressure measuring devices, level measuring devices, density measuring devices, temperature measuring devices, flow measuring devices, and/or pH sensors, each of which must be individually commissioned, in particular configured and/or parameterized, connected to the higher-level unit, and, if necessary, maintained and/or replaced.

For this purpose, field devices often feature a user interface and/or a display for showing measured values and, if necessary, diagnostic results determined by the field device. However, these components require a lot of space in the field device on a permanent basis, even though they are usually only needed sporadically during the operating time of the field device. A certain degree of remedy can be achieved here by equipping field devices with a wireless interface that allows them to communicate with a mobile operating device, such as a tablet or smartphone, when necessary. However, the wireless interface also requires space within the respective field device. In addition, different types of field devices require their own wireless certification. The latter increases manufacturing costs.

When connecting field devices to the higher-level unit's port, it must be ensured that the measured values are transmitted in accordance with a communication protocol that can be processed by the higher-level unit. In process and automation technology, however, several different communication protocols that can be used for this purpose, such as Hart, Foundation Fieldbus, and Modbus, have become established in parallel with one another. This means that several types of field devices must be provided to measure the same variable in different applications, each differing only in the communication protocol used to communicate with the higher-level unit.

DE 10 2013 107 964 A1 describes two variants of a measuring unit comprising a single sensor for measuring a measured variable, an adapter connected to the sensor via an inductive plug connector coupling, and an evaluation unit. The evaluation unit is designed to determine the sensor type of the sensor connected to the adapter based on its sensor identification and to determine measured values of the measured variable measured by the sensor based on a measurement signal generated by the sensor using a program module that can be selected based on the sensor identification.

In the first embodiment variant, the evaluation unit is integrated into the adapter, and the adapter comprises a radio interface for communication with a mobile operating device and a second interface, such as a fieldbus interface, via which the adapter can be connected to a higher-level unit, such as a control system or a process guidance system. The advantage here is that the sensor can be selected from a group of sensors for measuring different variables and can be replaced if necessary. However, one disadvantage is that space is required in the adapter to accommodate the evaluation unit. In addition, communication means are required in the adapter to enable communication with the sensor via the inductive connector coupling, communication with the operating device via the wireless interface, and communication with the higher-level unit via the second interface. Another disadvantage is that connecting the sensor to higher-level units that use different communication protocols requires a corresponding number of different adapter types, which differ only in the communication protocol used to communicate with the higher-level unit. As a result, each adapter type requires its own wireless certification.

In the second embodiment variant, the adapter, which is also connected to the sensor via the inductive connector coupling, is connected to a compact transmitter via a port interface. In this variant, the evaluation unit for evaluating the sensor's measurement signals is integrated into the compact transmitter, and the compact transmitter has a wireless interface for communication with the operating device and a second interface for the port of the compact transmitter to the higher-level unit. However, the disadvantage here is that communication between the operating device and the measuring unit takes place exclusively via the compact transmitter. If the connection between the compact transmitter and the adapter is disrupted, fails, or is missing, the compact transmitter can no longer identify the sensor, and it is not possible to access any measurement signals generated by the sensor or any data stored in the sensor from outside. Both of these factors complicate the commissioning of the measuring unit as well as any diagnosis and/or rectification of impairments to the measuring unit that may be necessary after commissioning. Furthermore, this embodiment variant is unsuitable for use at measuring points where many different measured variables need to be measured, as a separate measuring unit with a compact transmitter is required for each measured variable.

It is an object of the invention to provide a measuring system with one or more field devices that can be manufactured cost-effectively, offers flexibly adaptable connection options for each field device, enables communication with each field device that is as fail-safe as possible, and whose field devices can be connected efficiently to a higher-level unit.

For this purpose, the invention comprises a measuring system with one or more field devices for measuring at least one measured variable in each case, which comprises an adapter for each field device and which comprises a unit to which each field device can be connected or is connected via the adapter connected to the respective field device, in which:
each adapter comprises a communication unit that communicates in accordance with a system protocol, to which an adapter interface, a wireless interface, and a connection interface are connected,
each field device comprises a field device interface via which it is or can be connected to the adapter interface of the associated adapter,
the unit comprises a communication unit that communicates in accordance with the system protocol, to which a wireless interface and one or more port interfaces are connected, and
each field device can be connected to the unit both via a wireless interface connection between the wireless interface of the unit and the wireless interface of the adapter connected to the respective field device, and via a connection between one of the port interfaces of the unit and the port interface of the adapter connected to the respective field device, and
the unit comprises at least one gateway module communicating in accordance with a module-specific communication protocol, with a gateway interface connected thereto, via which the unit can be connected to a higher-level unit.

The measuring system offers the advantage that each field device can be connected to the system either via the associated wireless connection or, alternatively or additionally, via the associated port connection, without the need for different types of field devices that support different forms of communication. The wireless and port connections available in parallel for each field device offer the advantage that reliable communication is still possible even if one of the two connections fails, is disrupted, or is not available at the point of use. The parallel use of both connections offers the advantage of achieving higher data transfer speeds and/or improved protection against data transfer errors and hacker attacks.

Using the same system protocol for communication via wireless connections and port connections offers the advantage that only a single communication unit that communicates in accordance with the system protocol is required in the adapters. The latter is advantageous both in terms of manufacturing costs and with regard to any desired miniaturization of the adapters. Further advantages are that identical adapters can be used for all field devices, requiring only a single wireless certification, and field devices without a wireless certification can be used. Furthermore, only a single gateway module is required for connecting multiple field devices connected to the unit to the higher-level unit.

According to a first further design, the measuring system is designed for each field device to carry out communication between the respective field device and the unit according to a communication mode which can be selected from several predetermined communication modes by means of a corresponding configuration of the measuring system for the respective field device, wherein the communication modes for each field device respectively:
comprise at least one first communication mode in which communication between the field device and the unit takes place exclusively via the wireless connection between the unit and the adapter connected to the respective field device,
comprise a second communication mode in which communication between the field device and the unit takes place exclusively via the port connection between the unit and the adapter connected to the respective field device, and
comprise at least one dual communication mode in which communication between the field device and the unit takes place continuously or at specified intervals via the wireless connection and continuously or at specified intervals via the port connection.

One embodiment of the first further design provides for the dual communication modes:
comprise a basic mode in which communication takes place via the wireless connection and is switched over to the port connection in the event of a fault or failure of the wireless connection, and/or comprising a basic mode in which communication takes place via the port connection and is switched over to the wireless connection in the event of a fault or failure of the port connection,
comprise a high-speed mode in which data to be transmitted from the field device to the unit and/or from the unit to the field device is split into two data sets, one of which is transmitted via the wireless connection and the other via the port connection,
comprise a priority mode in which one of the two connections, namely the wireless connection or the port connection, is used as the primary connection over which communication between the field device and the unit takes place, and the other connection is used as the secondary connection over which emergency information and/or diagnostic results issued by the field device are transmitted and/or to which communication between the unit and the respective field device is redirected in the event of a fault or failure of the primary connection, and/or
comprise a security mode in which the data to be transmitted is transmitted in parallel via the wireless connection and the port connection.

A second further design provides that the communication unit of the unit and the communication unit of at least one or each adapter are each designed to communicate via the wireless connection(s) between the unit and in each case one of these adapters in two or more different transmission modes differing in their carrier frequencies.

One embodiment of the second further design provides that the communication in the individual transmission modes each takes place in a different part area of a frequency range available for communication via the respective wireless connection, and/or a frequency range available for communication via the respective wireless connection is divided into a plurality of channels each having a predetermined bandwidth and for each transmission mode a different, in particular a non-overlapping, subset of the channels is used for communication in accordance with the respective transmission mode.

Further embodiments of the second further design provide that
the communication unit of the unit and the communication unit of at least one or each adapter are each designed to communicate via the wireless connection(s) between the unit and in each case one of these adapters in such a manner that validation data, in particular parity data or handshake data, are transmitted via one of the transmission types, on the basis of which the authenticity and/or the consistency of data transmitted in parallel via another transmission type can be checked and/or is checked, and/or
the measuring system is designed with respect to the, at least one or each field device in each case to carry out the communication via the wireless connection between the respective field device and the unit in accordance with a wireless mode which can be selected from a plurality of predetermined wireless modes by a corresponding configuration of the measuring system for the respective field device, wherein the wireless modes for each field device in each case:
comprise a basic wireless mode in which communication takes place via one of the transmission modes and is switched to another transmission mode in the event of a fault or failure of the respective transmission mode,
comprise a priority wireless mode in which one of the transmission modes is used as the primary transmission mode over which the communication between the field device and the unit takes place, and a transmission mode other than the primary transmission mode is used as the secondary transmission mode over which emergency information and/or diagnostic results issued by the field device are transmitted and/or to which the communication over the wireless connection between the unit and the respective field device is switched in the event of a fault or failure of the communication over the primary transmission mode, and/or
comprise at least one security wireless mode in which data to be transmitted via the respective wireless connection is transmitted in parallel in at least two different transmission modes.

A third further design provides that the unit comprises a monitoring unit designed:
for the, at least one or each field device to be connected or connected to the unit, to determine in each case whether the respective field device is connected to the unit via the associated wireless connection and/or the associated port connection and to provide information about this,
to determine the signal strength of the respective wireless connection for each field device connected to the unit via the associated wireless connection and to provide information about this,
for the, at least one or each field device connected to the unit to monitor in each case a connection quality of the associated wireless connection and/or the associated port connection, and to detect a fault or a failure of the respective connection if the connection quality falls below a limit value predetermined for this purpose, and/or
for the, at least one, or each field device communicating with the unit in two or more transmission modes via the associated wireless connection, to monitor a connection quality of the connection via at least one or each transmission mode, and to detect a fault or a failure of the connection via the respective transmission mode if the associated connection quality falls below a predetermined limit value for this purpose.

In accordance with a further design of the third further design, the unit is designed to switch the communication running via one of the connections monitored by the monitoring unit to another connection in the event of a fault detected by the monitoring unit or a malfunction of the respective connection detected by the monitoring unit, wherein the unit is designed in particular:
to switch communication with each field device communicating with the unit in basic mode to the associated port connection in the event of a fault or failure of the associated wireless connection and/or to switch to the associated wireless connection in the event of a fault or failure of the associated port connection,
to switch communication with each field device communicating with the unit in priority mode to the secondary connection in the event of a fault or failure of the primary connection,
to switch the communication with each field device communicating with the unit in basic wireless mode to another transmission mode in the event of a fault or failure of the connection via one of the transmission modes, and/or
to switch the communication with each field device communicating with the unit in priority wireless mode to the connection via the secondary transmission mode in the event of a fault or failure of the connection via the primary transmission mode.

In accordance with a fourth further design, the unit comprises a test unit which is designed to perform a data integrity test using data transmitted to the unit in parallel in two or more different manners and to determine and make available an integrity test result by means of the data integrity test and/or to issue a corresponding warning and/or trigger an alarm in the event of an impairment of the data integrity determined by the data integrity test, wherein the data transmitted to the unit in parallel in two or more different manners comprise, in particular, data transmitted via one of the wireless connections and data transmitted in parallel via one of the port connections, and/or data transmitted in parallel in two or more transmission manners via one of the wireless connections.

A fifth further design provides that:
each adapter comprises a repeater which is designed to forward incoming data via the wireless interface of the respective adapter to the wireless interface of at least one other adapter and/or the wireless interface of the unit, and/or
the communication units of the adapters and the communication unit of the unit are designed as network nodes that can be connected to a wireless network via the wireless interfaces connected to them, wherein the wireless network has a network architecture, a grid-shaped network architecture or a star-shaped network architecture, is designed to transmit data to be sent from one network node to another network node on at least two different transmission paths, is designed in such a manner that a wireless connection can be established via the wireless network between the unit and the adapter of at least one field device arranged outside a wireless range of the unit, and/or is designed to transmit data to be sent from one of the network nodes to another network node on at least two different transmission paths.

In accordance with a sixth further design, the measurement system comprises a second unit to which the, at least one or each field device connectable or connected to the unit is connectable or connected, wherein:
the second unit is designed as a redundant unit which can optionally be operated permanently in parallel with the unit and/or takes over the function of the unit in the event of a fault or failure of the unit,
   and/or wherein:
   one of the two units is designed as a transmitter which sends data received from at least one or each field device connected to the transmitter to the other unit via a connection between the unit and the second unit, in particular a connection via the wireless interfaces of the two units or a connection via the module interfaces of the two units, and
   the other unit is designed as a receiver which receives the data transmitted by the transmitter, and comprises a test device which is designed to perform a data integrity test using at least one field device connected to both units, both via the wireless connection and/or the port connection between the field device and the receiver and in parallel via the connection received from the transmitter,
   wherein the test unit is designed to determine and make available a test result of the data integrity test and/or is designed to output a corresponding warning and/or trigger an alarm in the event of an impairment of data integrity determined by the data integrity test.

In accordance with a seventh further design, each adapter comprises a lighting apparatus with at least one lighting means, in particular a light-emitting diode or a light-emitting diode ring, for displaying at least one diagnostic result determined by the field device connected to the respective adapter and/or the unit for the field device connected to the respective adapter.

An eighth further design consists in that:
the gateway module or at least one of the gateway modules of the or each unit is designed as a replaceable component, as a plug-in slot card that can be plugged into a slot of the unit or as an expansion card that can be plugged into and/or connected to the unit,
which, at least one or each unit comprises two or more gateway modules, each communicating according to a different module-specific communication protocol, with gateway interfaces connected thereto, and/or comprises at least one further communication module with a module interface connected thereto, in particular an Ethernet module with an Ethernet interface and/or a mobile radio module with a mobile radio interface, and is designed to communicate via the respective module interface with a correspondingly designed communication partner, in particular an operating device, a further unit, an Internet platform and/or a database.

In accordance with a ninth further design, the measuring system comprises an operating device that:
comprises a user interface with display and input means, a data processing unit, operating software stored in a memory of the operating device and executable by means of the data processing unit, and a communication unit connected to the data processing unit and communicating in accordance with the system protocol, with a wireless interface connected thereto,
is designed to communicate by means of its communication unit with each field device which can be connected to the operating device via a wireless connection between the wireless interface of the operating device and the wireless interface of the adapter connected to the respective field device, and each unit which can be connected to the operating device via a wireless connection between the wireless interface of the operating device and the wireless interface of the unit, in each case in accordance with the system protocol, and
whose operating software is designed to provide a user interface to a user of the operating device via which the measuring system can be operated.

Further designs of the ninth design consists in the fact that the operating device:
is designed to identify each field device and/or each unit connected to one of the adapters, to read out a field device identifier stored in each field device and/or to display it directly and/or on request via the user interface, and/or to read out a field device identifier stored in each field device and/or to display it via the user interface immediately and/or on request,
comprises a positioning unit designed to locate field devices that can be connected or are connected to the operating device via the adapter connected thereto and/or units that can be connected or are connected to the operating device and to display their location directly or at the user's request via the user interface and/or make it available in another manner, and/or
at least one further communication module with a module interface, in particular an Ethernet module with an Ethernet interface and/or a mobile communications module with a mobile communications interface, and is designed to communicate via the module interface with the or each unit, with an Internet platform and/or with a database.

Further designs in the ninth design provide that:
the operation comprises identification, location, configuration, parameterization, and/or modification of the configuration and/or parameterization of at least one or each field device connected to one of the adapters, configuration and/or modification of the configuration of at least one or each lighting apparatus, and/or includes identification, location, configuration, parameterization, and/or modification of the configuration and/or parameterization of at least one or each unit,
the operating device is designed to display information to the user, wherein the information comprises measured values of the measured variable(s), diagnostic results for at least one of the field devices, the communication mode and/or wireless mode for each field device according to which the unit communicates with the respective field device, information that can be determined by means of the monitoring unit and/or the test unit of the unit and/or information that can be retrieved from an Internet platform or a database, in particular technical information, operating instructions, certificates, and/or explanatory videos, for each unit and/or each field device, and/or
the user interface is designed as a menu-based interface, wherein the menu comprises a system level, a unit level for each unit, and a field device level for each field device, wherein the menu is in particular on the system level, each unit is linked to the associated unit level via a link, on each unit level the field devices connected to the unit are each linked to the associated unit level via a link, and the user is offered a sub-menu, via the sub-menu items of which the user can carry out and/or change the configuration and/or parameterization of the unit, and/or a sub-menu is displayed to the user at each field device level, via the sub-menu items of which the user can carry out and/or change the configuration and/or parameterization of the field device and/or the configuration of the lighting apparatus of the adapter connected to the field device.

The invention and its advantages will now be explained in detail using the figures in the drawing, which show several examples of embodiments. The same elements are indicated by the same reference numbers. in the figures.

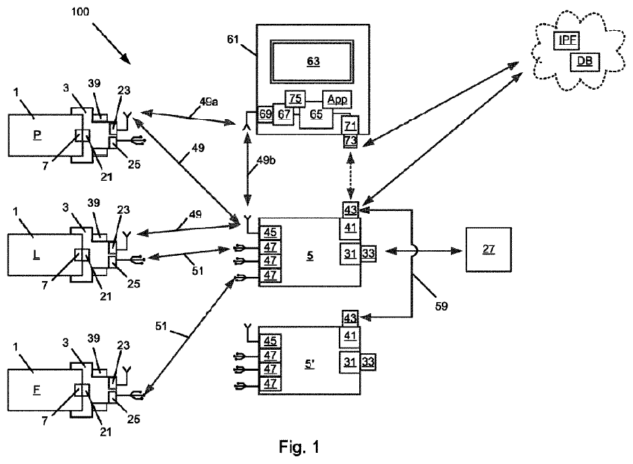

FIG. 1 shows: a measuring system;

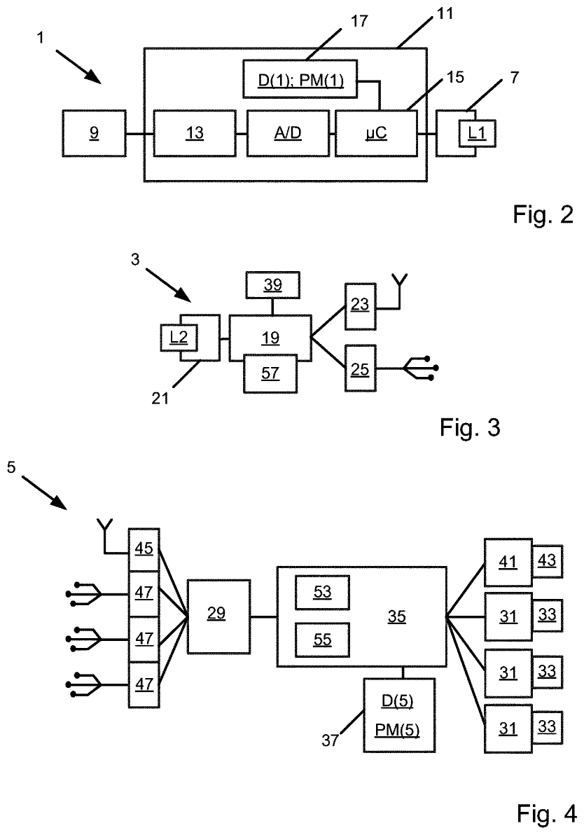

FIG. 2 shows: a block diagram of a field device;

FIG. 3 shows: a block diagram of an adapter;

FIG. 4 shows: a block diagram of a unit;

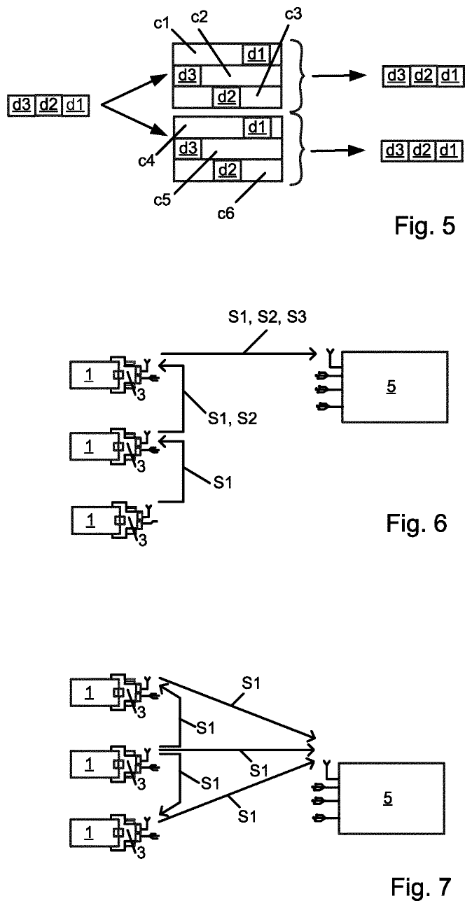

FIG. 5 shows: two transmission types;

FIG. 6 shows: a network architecture;

FIG. 7 shows: another network architecture;

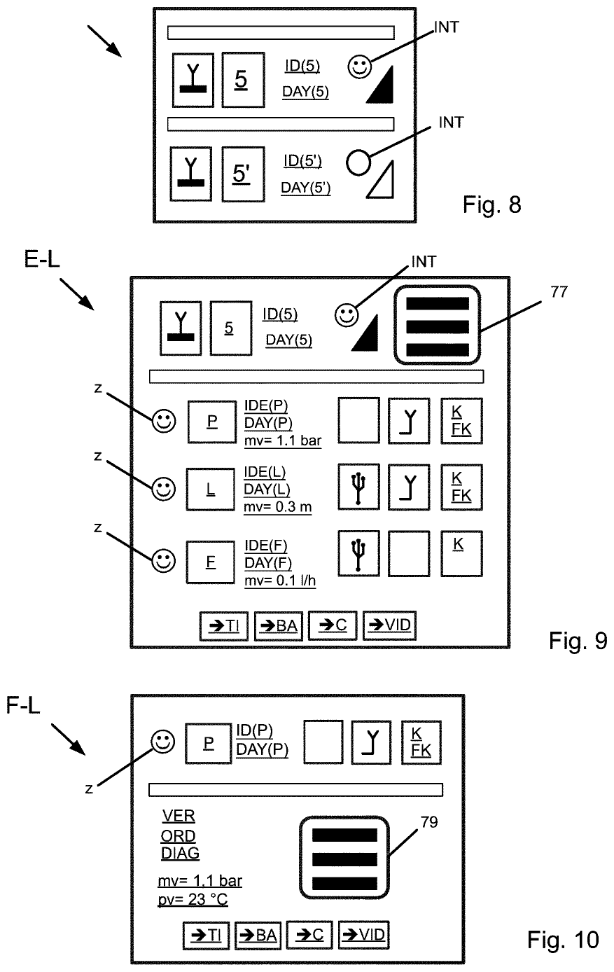

FIG. 8 shows: a system level of a menu;

FIG. 9 shows: a unit level of a menu; and

FIG. 10 shows: a field device level of a menu.

The invention comprises a measuring system 100 with one or more field devices 1. For each field device 1, the measuring system 100 comprises an adapter 3 connected or connectable to the respective field device 1. In addition, the measuring system 100 comprises a unit 5 to which each field device 1 of the measuring system 100 can be connected or is connected via the adapter 3 connected to the respective field device 1.

FIG. 1 shows an embodiment example in which three field devices 1 are connected to the unit 5, each via the adapter 3 connected to the respective field device 1. The field devices 1 shown as an example in FIG. 1 comprise, for example, a pressure sensor P for measuring a pressure, a level meter L for measuring a level and a flow meter F for measuring a flow rate. Alternatively, however, a different number of one or more field device(s) 1 and/or at least one field device 1 other than the field devices 1 shown can be used in measurement systems 100 according to the invention. In this respect, the field devices 1 comprise, for example, at least one measuring device, such as a density meter, and/or at least one sensor, such as an absorption sensor, a turbidity sensor and/or a pH sensor. Regardless of the type and number of field devices 1 used, each field device 1 is designed to measure at least one of the measured variables to be measured with the measuring system 100 and to provide a measurement signal corresponding to the respective measured variable. In addition, each field device 1 has a field device interface 7 via which it is connected or can be connected to the associated adapter 3.

FIG. 2 shows an example of a field device 1 comprising a measuring element 9 for measuring the measured variable and field device electronics 11 connected to the measuring element 9. The field device electronics 11 is connected to the field device interface 7 and is designed to generate the measurement signal and make it available, e.g. to output it or make it available in a retrievable form. For this purpose, the field device electronics 11 comprises, for example, an analog circuit 13 connected to the measuring element 9, an analog-to-digital converter A/D connected to the circuit 13 and a data processing unit 15 connected downstream of the analog-to-digital converter A/D, such as a microprocessor, to which the field device interface 7 is connected.

Depending on the embodiment, the field device 1 comprises, for example, a field device memory 17 for storing data D(1) and/or at least one program module PM(1) that can be executed by means of the data processing unit 15. The data D(1) stored in the field device memory 17 comprises e.g. a field device identifier permanently stored in the field device 1, field device configuration data, field device parameterization data, field device calibration data and/or other e.g. field device and/or measuring point-related data. The field device electronics 11 is designed, for example, to output data elements of the data D(1) stored in the field device memory 17 via the field device interface 7 and/or to receive data elements via the field device interface 7 and store them in the field device memory 17. Alternatively or additionally, the field device electronics 11 is designed, for example, to receive, store and execute at least one program module PM(1) and/or updates to at least one program module PM(1) stored in the field device memory 17 via the field device interface 7 and/or to replace program modules PM(1) stored in the field device memory 17 with program modules PM(1) received via the field device interface 7. Instead of the embodiment example shown in FIG. 2, field devices 1 with a different structure that can be connected to the associated adapter 3 via their field device interface 7 can also be used as an alternative.

Each field device 1 is designed to communicate via the adapter 3 connected to the respective field device 1 in accordance with a system protocol specified for the measuring system 100. For this purpose, each adapter 3 comprises a communication device 19 communicating in accordance with the system communication protocol, to which an adapter interface 21, a wireless interface 23 and a port interface 25 are connected. A block diagram of an embodiment of an adapter 3 is shown in FIG. 3. As shown in FIG. 1, each adapter 3 is connected or can be connected to the associated field device 1 via its adapter interface 21, which can be connected to the field device interface 7 of the field device 1 to be connected to the respective adapter 3. FIGS. 2 and 3 show an embodiment example in which the adapter interfaces 21 and the field device interfaces 7 are each designed as inductively coupling interfaces which comprise an inductance L1, L2, such as a coil, and whose inductances L1, L2 interact with each other to form a transformer via which digital communication takes place. Optionally, the field devices 1 can also be supplied with power via these transformers. Alternatively, other types of interfaces can also be used and/or the field devices 1 can be or are supplied with power in other ways. FIG. 1 shows an embodiment in which the adapter interfaces 21 and the field device interfaces 7 are designed as plug-in connections, e.g. as inductively coupling plug-in connections, which comprise complementary connecting elements that can be mechanically connected to one another, such as connecting elements that can be connected to one another via a bayonet catch. With inductive coupling plug-in connections, one of the two inductances L1, L2 of the transformer, for example, is arranged in the connecting elements in such a manner that the mechanical connection of the connecting elements also causes an inductive coupling of the two inductances L1, L2 forming the transformer. Alternatively, another form of mechanical attachment of the adapters 3 to the field devices 1 and/or another form of electrical connection of the adapter interfaces 21 and the field device interfaces 7 can be used.

Each field device 1 can be connected or is connected to the unit 5 via the adapter 3 connected to it. The unit 5 can be connected to a higher-level unit 27, such as a controller, a programmable logic controller, or a process guidance system, which is superior to the measuring system 100. An embodiment example of a block diagram of the unit 5 is shown in FIG. 4. The unit 5 comprises a communication unit 29, which is designed to communicate with each field device 1 connected to the unit 5 via one of the adapters 3 in accordance with the system protocol, and a gateway module 31 with a gateway interface 33, via which the unit 5 can be connected to the higher-level unit 27. The gateway module 31 is designed to communicate with the higher-level unit 27 in accordance with a module-specific communication protocol that can be processed by the higher-level unit 27. The unit 5 can be connected to the higher-level unit 27 via a wireless or wired connection, for example. Fieldbus communication protocols established in process and automation technology, such as Hart, Profibus, Foundation Fieldbus or Modbus, are suitable as module-specific communication protocols. With a wireless connection to the higher-level unit 27, communication can take place according to the wireless HART standard, for example. In the case of a wired connection to the higher-level unit, the gateway module 31 can, for example, have a two-wire current output via which communication takes place, for example, using 4 . . . 20 mA/HART signals, or a four-wire current output via which communication takes place, for example, using 4 . . . 20 mA/HART signals or in accordance with one of the other fieldbus communication protocols mentioned above. Alternatively, the gateway module 31 is designed, for example, to communicate with the higher-level unit 27 via an Ethernet standard, such as the Ethernet standard known under the English designation Advanced Physical Layer (APL).

The unit 5 is designed, for example, as a simple gateway that translates data transmitted to the unit 5 in accordance with the system protocol into data to be transmitted to the higher-level unit 27 in accordance with the module-specific communication protocol. Alternatively, the unit 5 is designed, for example, to perform at least one further function in addition to its function as a gateway. The unit 5 shown as an example in FIG. 4 comprises the communication unit 29, a data processing unit 35 connected to the communication unit 29, a unit memory 37 for storing data D(5) and/or at least one program module PM(5) which can be executed by means of the data processing unit 35 of the unit 5, and the gateway module 31 connected to the data processing unit 35 in FIG. 4.

The unit 5 can, for example, be equipped with only a single, permanently installed gateway module 31. Alternatively, the single gateway module 31 can be designed as a replaceable component. In this case, for example, it is designed as a plug-in slot card that can be plugged into a slot of the unit 5 and replaced if necessary. FIG. 4 shows an example in which unit 5 comprises two or more gateway modules 31, each designed as a permanently installed or replaceable component, which are each designed to communicate in accordance with a different module-specific communication protocol with the higher-level unit 27 that can be connected to the unit 5 via the respective gateway module 31. Alternatively or additionally, the measuring system 100 can comprise at least one gateway module 31 designed as an expansion card that can be plugged into and/or connected to the unit 5. Units 5 with at least one interchangeable gateway module 31, as well as units 5 with two or more different gateway modules 31, offer the advantage that they can be adapted very flexibly to the communication protocol that can be processed by the higher-level unit 27 at the place of use.

A further optional embodiment also shown in FIGS. 1 and 4 is that the unit 5 comprises at least one further communication module 41 with a module interface 43 connected thereto, such as an Ethernet module connected to the data processing unit 35 with an Ethernet interface and/or a mobile radio module connected to the data processing unit 35 with a mobile wireless interface. In this case, the unit 5 is designed, for example, to communicate via its Ethernet interface with a correspondingly designed communication partner, such as a computer, a laptop, a tablet, a smartphone, an operating device 61, another unit 5′, an Internet platform IPF and/or a database DB. The connection to the respective communication partner can be established via the Internet and/or an intranet, via a LAN connection or a WLAN connection, for example. Alternatively or additionally, the unit 5 is designed, for example, to communicate via its mobile wireless interface with a correspondingly designed communication partner, such as a smartphone, an operating device and/or a further unit 5′ in accordance with a mobile wireless standard, such as GSM, 4G or 5G. Each of these communication modules 41 offers the advantage that larger amounts of data can be transmitted with a high data transmission rate and/or low latency.

The data D(5) stored in the unit memory 37 of the unit 5 comprises, for example, unit-related data, such as a unit identifier by means of which the unit 5 can be identified, unit configuration data and/or unit parameterization data. Alternatively or additionally, they comprise, for example, field device-related data, such as the field device identifier, field device configuration data and/or field device parameterization data for at least one or each field device 1 that can be connected or is connected to the unit 5. Additionally, further data, e.g. relating to the unit, field device and/or measuring point, can also be or be stored in the unit memory 37.

The program modules PM(5) stored in the unit memory 37 comprise, for example, program modules required for commissioning and/or basic operation of the unit 5 and/or program modules extending the functionality of the unit 5. Depending on the embodiment and purpose of the respective program module PM(5), the data processing unit 35 is designed, for example, to execute the respective program module PM(5) on the basis of data received via the communication unit 29 of the unit 5 and/or data stored in the unit memory 37, and/or to make a result determined by the execution of the respective program module PM(5) available to the unit 5 via the communication unit 29, via the communication module 41 and/or via the gateway module 31.

An optional embodiment is that the program modules PM(5) each comprise a field device module for at least one or each field device 1, which is designed to determine measured values of the measured variable measured by the respective field device 1 using the measurement signals transmitted by the respective field device 1 and/or to perform a diagnosis using measurement signals, diagnostic signals and/or parameters transmitted by the field device 1 and to determine a diagnostic result, such as a state of the respective field device 1, and to make it available, for example, via the communication unit 29 and/or the gateway module 31. This embodiment variant offers the advantage that a corresponding evaluation and/or diagnostic unit can be dispensed with in the respective field device 1. Field devices 1 without an evaluation and/or diagnostic unit offer the advantage that they can be manufactured more cost-effectively and may also have smaller dimensions. A further advantage is that the measurement signals, diagnostic signals and/or parameters transmitted by the field device 1 provide only a very small amount of information to a third party intercepting the communication between the unit 5 and the respective field device 1 without authorization. Alternatively, at least one of the field devices 1 can each comprise an evaluation and/or diagnostic unit. In this case, the unit 5 is designed, for example, to receive the measured values and/or the diagnostic results of these field devices 1 and to make them available via their communication unit 29 and/or the gateway module 31.

If the measuring system 100 is designed to determine diagnostic results for at least one of the field devices 1, the adapters 3 can optionally each comprise, for example, a lighting apparatus 39 with at least one light source, such as a light-emitting diode or a light-emitting diode ring, for displaying at least one diagnostic result assigned to the respective field device 1, such as its field device status. This offers the advantage that relevant diagnostic results are immediately recognizable at the location where the field device 1 is used. Alternatively, adapter 3 can also be used without lighting apparatus 39.

A further optional embodiment is that the unit 5 is designed to receive data via its communication unit 29 and/or its communication module(s) 41 and to store it in the unit memory 37, and/or to receive program modules PM(5) and/or updates to program modules PM(5) stored in the unit memory 37, to store them in the unit memory 37 and/or to execute them. This offers the advantage that the unit 5 can be configured and/or parameterized via received data and the configuration and/or parameterization can be changed if necessary. Furthermore, it offers the advantage that the unit 5 can be updated and the functionality of the unit 5 can be extended and/or modified by received program modules PM(5).

Regardless of whether or not the unit 5 has the optional embodiments described above, the unit 5 comprises a wireless interface 45 connected to its communication unit 29 communicating according to the system protocol and one or more connection interfaces 47 connected to its communication unit 29. This ensures that each field device 1 to be connected to the unit 5 can be connected to the unit 5 both via a wireless connection 49 between the wireless interface 45 of the unit 5 and the wireless interface 23 of the adapter 3 connected to the respective field device 1 and, alternatively or additionally, via a port connection 51 between the port interface 47 or one of the port interfaces 47 of the unit 5 and the port interface 25 of the adapter 3 connected to the respective field device 1. Accordingly, the unit 5 is designed to communicate with each field device 1 connected to it via a wireless connection 49 via the respective wireless connection 49 and to communicate with each field device 1 connected to it via a connection 51 via the respective connection 51.

Communication via the wireless connection(s) 49 can, for example, take place in accordance with a standard specified for this purpose, such as a Bluetooth® standard, a Long Range Wide Area Network (LoRaWAN) standard or a standard for a wireless network, such as a WiFi mesh. In this case, the wireless interface 45 of the unit 5 and the wireless interface 23 of each adapter 1 each have a wireless transceiver, for example, which is designed to communicate wirelessly in accordance with the specified standard. Each port connection 51 can, for example, be or be effected by a cable via which the connection interface 25 of the respective adapter 3 can be connected or is connected to the associated connection interface 47 of the unit 5. Alternatively, a wireless transmitter can be or is connected to each of the port interfaces 25, 47 to be connected to each other for wireless connection of the port interfaces 25, 47 to be connected to one another.

The wireless connections 49 offer the advantage that they can be set up at the location where the measuring system 100 is used without the need to lay cables. Additionally, at least one further field device 1 can be connected to the unit 5 via an additional wireless connection 49 even if all port interfaces 47 of the unit 5 are already occupied by a field device 1 connected to it. Wired port connections 51 offer the advantage over wireless connections 49 that they are less susceptible to interference and a higher data transmission rate can be achieved. Accordingly, wireless connections 49 are particularly suitable for field devices 1 that measure variables whose measured values are only required sporadically and/or whose measured values are only of secondary importance for the safety and/or operation of the measuring point. In contrast, port connections 51 are particularly suitable for field devices 1 that measure variables relevant to the safety and/or operation of the measuring point. The parallel use of wireless connections 49 and port connections 51 is particularly suitable for field devices 1 that are used to measure highly safety-relevant and/or particularly important measured variables for the operation of the measuring point, and/or for which a high degree of reliability, a high degree of data transmission security and/or a high data transmission rate is desired.

To illustrate the port options achieved by the measuring system 100, FIG. 1 shows an example in which the field device 1 designed as a pressure sensor p is connected to the unit 5 exclusively via the associated wireless connection 49, the field device 1 designed as a level measuring unit L is connected to the unit 5 via the associated wireless connection 49 and via the associated port connection 51, and the field device 1 designed as a flow measuring unit F is connected to the unit 5 exclusively via the associated port connection 51.

The invention has the advantages mentioned above. Individual components of the measuring system 100 can each have configurations that can be used individually and/or in combination with one another.

One embodiment consists in the measuring system 100 being designed for each field device 1 to carry out communication between the respective field device 1 and the unit 5 in accordance with a communication mode K, which can be selected from several predefined communication modes by configuring the measuring system 100 accordingly for the respective field device 1. These communication modes comprise for each field device 1 e.g. at least one first communication mode, in which communication between the field device 1 and the unit 5 takes place exclusively via the wireless connection 49 between the unit 5 and the adapter 3 connected to the respective field device 1, a second communication mode, in which the communication between the field device 1 and the unit 5 takes place exclusively via the port connection 51 between the unit 5 and the adapter 3 connected to the respective field device 1, and at least one dual communication mode in which the communication between the field device 1 and the unit 5 takes place permanently or in predetermined time periods via the wireless connection 49 and permanently or in predetermined time periods via the port connection 51.

The dual communication modes include, for example, a basic mode in which communication takes place via the wireless connection 49 and is switched over to the port connection 51 in the event of a fault or failure of the wireless connection 49, and/or a basic mode in which communication takes place via the port connection 51 and is switched over to the wireless connection 49 in the event of a fault or failure of the port connection 51.

Alternatively or additionally, the dual communication modes include, for example, a high-speed mode in which data to be transmitted from the field device 1 to the unit 5 and/or from the unit 5 to the field device 1 are each split into two data sets to achieve a higher data transmission rate, one of which is transmitted via the wireless connection 49 and the other via the port connection 51.

Alternatively or additionally, the dual communication modes include, for example, a priority mode in which one of the two connections, namely the wireless connection 49 or the port connection 51, is used as the primary connection over which regular communication between the field device 1 and the unit 5 takes place, and the other connection is used as the secondary connection over which emergency information and/or diagnostic results, such as an alarm, a warning and/or an error message, issued by the field device 1 are transmitted, and/or to which the communication between the unit 5 and the respective field device 1 is redirected in the event of a fault or failure of the primary connection. In this case, the emergency information and/or the diagnostic results are determined by the respective field device 1, for example, in each case by means of a program module PM(1) stored in the field device 1, which is designed, for example, to monitor the state of the field device 1 and/or to carry out a diagnosis, and to transmit the emergency information and/or the diagnostic results to the unit 5 via the field device interface 7 of the respective field device 1.

Alternatively or additionally, the dual communication modes include, for example, a security mode in which the data to be transmitted is transmitted in parallel via the wireless connection 49 and the port connection 51. This offers the advantage of greater reliability.

A further optional embodiment variant is that the communication unit 29 of the unit 5 and the communication unit 19 of at least one or each adapter 3 are each designed to communicate via the wireless connection(s) 49 between the unit 5 and one of these adapters 3 in each case in two or more different transmission modes differing in their carrier frequencies. Communication in the individual transmission modes takes place, for example, in a different sub-range of a frequency range available for communication via the respective wireless connection 49. For example, in the case of radio communication in accordance with a standard used, such as Bluetooth®, in which communication takes place within a frequency range that is divided into several channels each having a predetermined bandwidth, a different, in particular a non-overlapping, subset of the channels can be used for communication in accordance with the respective transmission type for each transmission type. FIG. 5 shows an embodiment example of a sequence of data packages d1, d2, d3, which are transmitted to a receiver in two different transmission modes, e.g. according to the principle of frequency hopping. In FIG. 5, the data packages d1, d2, d3 are transmitted to the receiver in the first transmission mode via a subgroup of the channels c1 to c6 available for communication, comprising the channels c1, c2, c3 in FIG. 5, and in parallel thereto in the second transmission mode via a second subgroup of the channels c1 to c6 available for communication, comprising the channels c4, c5 and c6 in FIG. 5, which is different with respect to the carrier frequencies used at the same time. Alternatively, however, other forms of wireless communication can also be used, such as wireless communication via a long range wide area network (LoRaWAN) or a wireless, e.g. grid-shaped network, in which the frequency range available for data transmission can be divided into two or more sub-ranges that can each be used or utilized for one of the transmission types.

In this embodiment, the measuring system 100 is designed, with respect to the single or at least one or each field device 1, to carry out communication via the wireless connection 49 between the respective field device 1 and the unit 5 in accordance with a wireless mode FK, which can be selected from a plurality of predetermined wireless modes by configuring the measuring system 100 accordingly for the respective field device 1.

The wireless modes include, for example, a basic wireless mode in which communication takes place via one of the transmission types and is switched to another transmission type in the event of a fault or failure of the respective transmission type. Alternatively or additionally, the wireless modes for each field device 1 include, for example, a priority wireless mode in which one of the transmission types is used as the primary transmission type for communication between the field device 1 and the unit 5, and a transmission type different from the primary transmission type is used as a secondary transmission type, via which emergency information and/or diagnostic results output by field device 1, such as an alarm, a warning, and/or an error message, and/or to which the communication between the unit 5 and the respective field device 1 via the radio connection 49 is switched in the event of a fault or malfunction of the wireless communication via the primary transmission mode. Alternatively or additionally, the wireless modes include, for example, a security wireless mode in which data to be transmitted via the respective wireless connection 49 is transmitted in parallel using at least two different transmission types. The redundancy achieved in this way offers the advantage of greater reliability.

Regardless of the choice of wireless mode, the communication unit 29 of the unit 5 and the communication unit 19 of at least one or each adapter 3 are each optionally designed, for example, to communicate via the wireless connection(s) 49 between the unit 5 and each of these adapters 3 in such a manner that validation data, such as parity data or handshake data, is transmitted via one of the available transmission types, on the basis of which the authenticity and/or consistency of data transmitted in parallel via another transmission type can be and/or is checked.

One embodiment variant of the measuring system 100 comprises the unit 5 including a monitoring unit 53. The monitoring unit 53 is designed, for example, to determine for at least one or each field device 1 to be connected or connected to the unit 5 whether the respective field device 1 is connected to the unit 5 via the associated wireless connection 49 and/or the associated port connection 51, and to provide information about this. With regard to the wireless connections 49, it is preferably also designed to determine and provide a signal strength for the respective wireless connection 49. Alternatively or additionally, the monitoring unit 53 is designed, for example, to monitor the connection quality of the associated wireless connection 49 and/or the associated port connection 51 for at least one of the field devices 1 connected to the unit 5 and to detect a fault or failure of the respective connection if the connection quality falls below a specified threshold value. Alternatively or additionally, the monitoring unit 53 is designed, for example, to monitor the connection quality of the connection via at least one or each transmission type for the at least one or each field device 1 communicating with the unit 5 via the associated wireless connection 49 using two or more transmission types, and detect a fault or failure in the connection via the respective transmission type if the associated connection quality falls below a specified threshold value.

In this embodiment variant, the unit 5 is designed, for example, to switch the communication running via one of the connections monitored by the monitoring unit 53 to another connection in the event of a failure detected by the monitoring unit 53 or a malfunction of the respective connections detected by the monitoring unit 53. In this respect, unit 5 is designed, for example, to switch communication with each field device 1 communicating with unit 5 in basic mode to the associated connection 51 in the event of a fault or malfunction of the associated wireless connection 49 and/or to switch to the associated wireless connection 49 in the event of a fault or failure of the associated connection 51. Similarly, it is designed, for example, to switch communication with each field device 1 communicating with the unit 5 in priority mode to the secondary connection in the event of a fault or failure of the primary connection. Alternatively or additionally, unit 5 is designed, for example, to switch communication with each field device 1 communicating with unit 5 in basic wireless mode to another transmission mode in the event of a fault or failure of the connection via one of the transmission modes. Similarly, it is designed, for example, to switch communication with each field device 1 communicating with the unit 5 in priority wireless mode from the primary transmission mode to the secondary transmission mode in the event of a fault or failure of the connection.

In a further embodiment, the unit 5 comprises a test unit 55 adapted to perform a data integrity test using data transmitted to the unit 5 in two or more different ways. In this respect, the test unit 55 is designed, for example, to perform integrity tests on data received both via one of the wireless connections 49 and via one of the port connections 51. Alternatively or additionally, the test unit 55 is configured, for example, to perform integrity tests on data received in two or more different transmission modes via one of the wireless connections 49. Here, the test unit 55 is designed, for example, to determine and make available an integrity test result and/or to output a corresponding warning and/or trigger an alarm in the event of an impairment of data integrity determined by the data integrity test.

The monitoring unit 53 and/or the test unit 55 are implemented in the unit 5, for example in the form of program modules PM(5) stored in the unit 5, which are designed to perform the respective function.

A further embodiment of the measuring system 100 is that the communication units 19 of the adapters 3 and the communication unit 29 of the unit 5 are designed as network nodes that can be connected to a wireless network via the wireless interfaces 23, 45 connected to them. FIG. 3 shows an example of this, in which the communication units 19 of the adapters 3 each have a repeater 57 that is designed to forward incoming data via the wireless interface 23 of the respective adapter 3 to the wireless interface 23 of at least one other adapter 3 and/or the wireless interface 45 of the unit 5. This embodiment offers the advantage that at least one field device 1 located outside the wireless range of the unit 5 can also be connected via the wireless network, in each case via a wireless connection 49 running from the adapter 3 connected to the respective field device 1 to the unit 5 via the repeater 57 and at least one further adapter 3. The data to be transmitted via the wireless network and the data transmission paths on which data is transmitted within the wireless network can be specified, e.g., by configuring the unit 5 and/or the adapters 3 accordingly. FIG. 6 shows an embodiment example in which the adapters 3 connected to the field devices 1 are arranged at different spatial distances from the unit 5. In FIG. 6, the wireless network is designed such that data S1, S2 transmitted by field devices 1 located further away from unit 5 via their adapters 3 is transmitted to unit 5 via repeater 57 and at least one additional adapter 5 located between the transmitting adapter 3 and unit 5. Similarly, data to be transmitted from unit 5 to the respective remote field device 1 is transmitted via repeater 57 to at least one adapter 3 located at a shorter distance from unit 5 to the adapter 3 connected to the remote field device 1. Alternatively, a different network architecture, such as a mesh or star network architecture, can be used. For example, to increase reliability, a network architecture can be used that is designed to transmit data to be sent from one network node to another network node via at least two different transmission paths. FIG. 7 shows an example of this, in which data S1 to be transmitted from the middle field device 1 via its adapter 3 to the unit 5 is transmitted both directly and in parallel via the adapters 3 of the other two field devices 1.

A further embodiment consists in measuring system 100 comprising a second unit 5′, also shown as an option in FIG. 1, to which the at least one or each field device 1 connected to unit 5 can be connected or is connected. The second unit 5′ can, for example, be designed as a redundant unit that can be operated either permanently in parallel with unit 5 and/or takes over the function of unit 5 in the event of a fault or failure of unit 5. The second unit 5′ is identical in construction to unit 5, for example. Alternatively, however, it may also have reduced functionality sufficient for bridging operation.

Alternatively or additionally, unit 5 and second unit 5 can be connected to one another via at least one connection, such as a connection running via the wireless interfaces 45 of the two units 5, 5′, and/or a connection 59 running via the module interfaces 43 of the two units 5, 5′, and at least one of the field devices 1 may be or become connected to both units 5, 5 via the associated wireless connection 49 and/or the associated port connection 51. In this case, one of the two units 5, 5′ is designed as a transmitter, which sends data received from at least one or each of the field devices 1 connected to it to the other unit 5′, 5 via the connection 59. The other unit 5, 5′ is designed as a receiver which receives the data transmitted by the transmitter and comprises a test unit, such as the test unit 55 described above. This test unit 55 is designed to perform a data integrity test on the basis of at least one field device 1 connected to both units 5, 5′ both via the wireless connection 49 and/or the port connection 51 between the field device 1 and the receiver and, in parallel, via the connection 59 between the two units 5, 5′ received from the transmitter. Here, the test unit 55 is also designed with respect to this data to determine an integrity test result and make it available and/or to output a corresponding warning and/or trigger an alarm in the event of an impairment of the data integrity determined by the data integrity test. The test result can be output or made available in a readable form, for example, in a manner specified by a configuration of the receiver, e.g., via the wireless interface 45, the gateway interface 33, and/or the module interface 41 of the receiver.

A further embodiment provides that the measuring system 100 comprises an operating device 61, which is also shown as an option in FIG. 1. The operating device 61 comprises a user interface 63 with display and input means, a data processing unit 65, an operating software app stored in a memory of the operating device 61 and executable by means of the data processing unit 65, and a communication unit 67 connected to the data processing unit 65, communicating in accordance with the system protocol, with a wireless interface 69 connected thereto. The operating device 61 is designed as a mobile device, for example. In this respect, the operating device 61 is designed, for example, as a smartphone, tablet, or laptop. The user interface 63 is designed as a touchscreen, for example. Alternatively, it may also comprise separate display and input means, such as a display and a keyboard. The operating software app is designed to provide a user of the operating device 61 with a user interface through which the measuring system 100 can be operated. For this purpose, the operating software app is designed, for example, as an application installed on the operating device.

The operating device 61 is designed to communicate with each field device 1 connected to the operating device 61 via a wireless connection 49a between the wireless interface 69 of the operating device 61 and the wireless interface 23 of the adapter 3 connected to the respective field device 1, using its communication unit 67 and each unit 5, 5′ connectable to the control unit 61 via a wireless connection 49b between the wireless interface 69 of the control unit 61 and the wireless interface 45 of the unit 5, 5′, each in accordance with the system protocol. This offers the advantage that the operating device 61 can communicate with the field devices 1 even before they are connected to the unit 5, 5′.

In this respect, the operating device 61 is designed, for example, to identify each field device 1 and/or each unit 5, 5′ connected to one of the adapters 3. The identification is implemented in the operating software app, for example, in such a manner that the operating device 61 determines devices communicating in accordance with the system protocol, reads their device IDs, and displays them to the user via the user interface immediately and/or upon request. Each field device 1 is identified, for example, by the field device identifier read out by the operating device 61 from the field device memory 17 of the respective field device 1, and each unit 5, 5′ is identified, for example, by the unit identifier read out by the operating device 61 from the unit memory 37 of the respective unit 5, 5′.

Alternatively or additionally, the operating device 61 comprises, for example, a positioning unit 75 connected to the communication unit 67 of the operating device 61, which is designed to communicate with field devices 1 and/or to display and/or make available in other ways, via the user interface, units 5, 5′ that can be connected or are connected to the control device 61, along with their locations, either immediately or upon request by the user. Suitable positioning units 75 include, for example, positioning systems known from mobile communications, such as positioning units based on triangulation methods using reception signal strengths, positioning units based on mapping methods using reception signal strengths, and positioning units based on signal propagation time measurements.

Optionally, the operating device 61 comprises at least one further communication module 71 with a module interface 73 connected thereto, such as an Ethernet module connected to the data processing unit 65 with an Ethernet interface and/or a wireless communication module connected to the data processing unit 65 with a wireless communication interface, and is designed to communicate, if necessary, via the module interface 73 with at least one correspondingly designed communication partner, such as the or each unit 5, 5′, the Internet platform IPF, and/or the database DB.

With regard to the operation of the measuring system 100, the operating software app is designed, for example, to provide the user interface in such a manner that the user interface can be used to identify and/or locate each field device 1 and/or each unit 5 connected to one of the adapters 3, 5′, configuration and/or parameterization of the or each unit 5, 5′, and/or configuration and/or parameterization of each field device 1 can be performed.

The configuration and/or parameterization of each unit 5, 5′ that can be carried out by the user via the user interface includes, for example, assigning a unit designation, selecting and commissioning the gateway module 31 to be used at the place of use, for at least one or each field device 1, the selection and commissioning of the communication mode K to be used for communication with the respective field device 1 and/or the wireless mode FK to be used for communication with the respective field device 1, and/or the selection and commissioning of at least one program module PM(5) stored in the respective unit 5, 5′. Alternatively or additionally, program modules PM(5) to be used by unit 5, 5′, for example, can be selected by the user via the user interface of operating device 61 and then loaded from the memory of operating device 61 into unit 5, 5′, or retrieved from an external source, such as the Internet platform IPF and/or the database DB, via the control device 61 and stored in the unit 5, 5′.

The configuration and/or parameterization of at least one or each field device 1 comprises, for example, assigning a field device designation, the selection of a measuring range, the selection of a unit in which measured values of the measured variable measured by the respective field device 1 are to be output, the selection and/or specification of program modules PM(1) to be used for determining the measured values and/or the diagnostic results, and/or the selection and/or specification of field device configuration data, field device parameterization data, and/or other data, e.g., field device and/or measuring point-related data. Thereby, data and/or program modules can also be loaded from the memory of the operating device 61 into the respective field device 1 via the user interface, transmitted to the field device 1 by the unit 5, 5′ connected to the respective field device 1 via the operating device 61, or retrieved from the Internet platform IPF or the database DB via the operating device 61 and transmitted to the respective field device 1 via the operating device 61 and/or the unit 5, 5′ connected to the field device 1.

In connection with measuring systems with adapters 3 with lighting apparatus 39, the operating software app is designed, for example, to provide the user interface in such a manner that the lighting apparatus 39 of the adapters 3 can be configured via the user interface. As part of this configuration, the user selects, for example, the information to be displayed by the lighting apparatus 39 of the respective adapter 3. Depending on the embodiment of the lighting apparatus 39, a display mode, such as a color representing the information, and/or a display by continuous or flashing illumination of the associated light source, can also be selected for at least one selected piece of information.

Alternatively or additionally, the operating software app is designed, for example, in such a manner that the configuration and/or the parameterization of the unit(s) 5, 5′ and/or the field devices 1 can be changed via the user interface if required, and/or updates and/or an exchange of program modules PM(1) stored in the field device memories 17 and/or program modules PM(5) stored in the unit memory 37 can be carried out if required.

The operating software app is preferably also designed in such a manner that the user can display information, such as measured values of the individual measured variables, diagnostic results, such as the status of the field devices 1, and/or other information via the user interface. The further information includes, for example, the communication modes K and/or the wireless modes FK according to which the unit 5, 5′ communicates with the field devices 1 connected thereto, as well as information that can be determined by means of the monitoring unit 53 and/or test unit 55 of the unit 5, 5′. Alternatively or additionally thereto, the information comprises, for example via the module interface 73 of the user interface 61, information that can be retrieved in each case from external sources, such as the Internet platform IPF and/or the database DB, such as technical information TI, operating instructions BA, explanatory videos VID for operation and/or commissioning and/or certificates C for at least one or each field device 1 and/or at least one or each unit 5, 5′ of the measuring system 100.

The user interface is designed as a menu-based interface, for example. The menu has several menu levels, for example, between which the user can switch using the links provided in the individual levels. The menu levels are structured e.g. hierarchically and/or comprise e.g. a system level S-L, a unit level E-L for each unit 5, 5′ and a field device level F-L for each field device 1. An embodiment example of the system level S-L is shown in FIG. 8. FIG. 9 shows an embodiment example of the unit level E-L of the unit 5 and FIG. 10 shows an embodiment example of a field device level F-L of the field device 1 designed as a pressure sensor p.

At the system level S-L, the user is shown, for example, the or each unit 5, 5′ of the measuring system 100. Optionally, at least one piece of additional information is displayed for each unit 5, 5′, such as, for example, the signal strength available for communication with the respective unit 5, 5′, the unit identifier ID(5), ID(5′), and possibly also the unit identifier TAG(5), TAG(5′) already assigned to the respective unit 5, 5′, and/or an integrity test result INT determined by the test unit 55 of the respective unit 5, 5′. If one of the units 5, 5′ is connected to the operating device 61, this unit 5 is displayed in a highlighted position, e.g. in a header. At system level S-L, each unit 5, 5′ is linked to the corresponding unit level E-L, for example, via a link which the user can use to access the respective unit level E-L if required.

On the unit levels E-L, the user is shown the selected unit 5 and optionally at least one of the additional information items for the respective unit 5. In addition, the user is offered a sub-menu 77, via the sub-menu items of which the user can carry out and/or change the configuration and/or parameterization of the unit 5.

In FIG. 9, the field devices 1 connected to the unit 5 are also displayed to the user at the unit level E-L. Optionally, at least one piece of additional information is displayed to the user for each field device 1, such as the field device ID (P), the field device designation TAG(P), the status Z of the field device 1, the measured value my currently determined with the field device 1, and/or the communication mode K, and, if applicable, the wireless mode FK in which communication between the unit 5 and the respective field device 1 takes place. At unit level E-L, the individual field devices 1 are each linked to the corresponding field device level F-L, for example, via a link, which the user can use to access the respective field device level F-L if required.

The selected field device 1 is displayed to the user at field device level F-L. Optionally, at least one of the additional information about the respective field device 1 and/or at least one other piece of information, such as a version specification VER of the firmware used in the field device 1, an order code ORD, under which a replacement device can be ordered from the manufacturer if required, and/or a parameter value pv of a parameter determined with the field device 1 is displayed on the field device levels F-L. At the field device level F-L, the user is shown a sub-menu 79 for the field device 1, via whose user-selectable sub-menu items the user can, for example, carry out and/or change the configuration and/or parameterization of the field device 1 and, if necessary, also the configuration of the lighting apparatus 39 of the adapter 3 connected to the field device 1.

Optionally, on at least one unit level E-L and/or at least one field device level F-L, for example, in each case at least one query is linked to an information source, such as the Internet platform IPF and/or the database DB, via which the user can display, for example, technical information TI, operating instructions BA, certificates C, and/or explanatory videos VID relating to the respective unit 5, 5′ or the respective field device 1.

List of reference signs

| | | | |
|---|---|---|---|
| 100 | measuring system | 41 | communication module |
| 1 | field device | 43 | module interface |
| 3 | adapter | 45 | wireless interface |
| 5 | unit | 47 | port interfaces |
| 7 | field device interface | 49 | wireless connection |
| 9 | measuring element | 51 | port connection |
| 11 | field device electronics | 53 | monitoring unit |
| 13 | circuit | 55 | test unit |
| 15 | data processing unit | 57 | repeater |
| 17 | field device memory | 59 | connection |
| 19 | communication unit | 61 | operating device |
| 21 | adapter interface | 63 | user interface |
| 23 | wireless interface | 65 | data processing unit |
| 25 | port interface | 67 | communication unit |
| 27 | higher-level unit | 69 | wireless interface |
| 29 | communication unit | 71 | communication module |
| 31 | gateway module | 73 | module interface |
| 33 | gateway interface | 75 | positioning unit |
| 35 | data processing unit | 77 | sub-menu |
| 37 | unit memory | 79 | sub-menu |
| 39 | lighting apparatus | | |

1-16. (canceled)

17. A measuring system having one or more field devices for measuring at least one measured variable in each case, which comprises a respective adapter for each field device, and which comprises a unit to which each field device can be connected or is connected via the respective adapter connected to the respective field device, in which:
each adapter comprises a communication unit communicating in accordance with a system protocol, to which an adapter interface, a wireless interface and a connection interface are connected,
each field device comprises a field device interface via which it is connected or can be connected to the adapter interface of the associated adapter,
the unit comprises a communication unit communicating in accordance with the system protocol, to which a wireless interface and one or more connection interfaces are connected, and
each field device can be connected to the unit both via a wireless connection between the wireless interface of the unit and the wireless interface of the adapter connected to the respective field device, and via a port connection between one of the port interfaces of the unit and the port interface of the adapter connected to the respective field device, and
the unit comprises at least one gateway module communicating in accordance with a module-specific communication protocol and having a gateway interface connected thereto, via which the unit can be connected to a higher-level unit.

18. The measuring system according to claim 17, which, with respect to each field device, is designed in each case to carry out the communication between the respective field device and the unit in accordance with a communication mode which can be selected from a plurality of predetermined communication modes by corresponding configuration of the measuring system for the respective field device, wherein the communication modes for each field device in each case:
comprise at least a first communication mode in which communication between the field device and the unit takes place exclusively via the wireless connection between the unit and the adapter connected to the respective field device,
comprise a second communication mode in which the communication between the field device and the unit takes place exclusively via the port connection between the unit and the adapter connected to the respective field device, and
comprise at least one dual communication mode in which communication between the field device and the unit takes place permanently or at predetermined intervals via the wireless connection and permanently or at predetermined intervals via the port connection.

19. The measuring system according to claim 18, in which the dual communication modes:
comprise a basic mode in which communication takes place via the wireless connection and is switched over to the port connection in the event of a fault or failure of the wireless connection, and/or comprise a basic mode in which communication takes place via the port connection and is switched over to the wireless connection in the event of a fault or failure of the port connection,
comprise a high-speed mode in which data to be transmitted from the field device to the unit and/or from the unit to the field device are each split into two data sets, one of which is transmitted via the wireless connection and the other via the port connection,
comprise a priority mode in which one of the two connections, namely the wireless connection or the port connection, is used as the primary connection over which communication between the field device and the unit takes place, and the other connection is used as the secondary connection over which emergency information and/or diagnostic results issued by the field device are transmitted and/or to which communication between the unit and the respective field device is redirected in the event of a fault or failure of the primary connection, and/or
comprise a security mode in which the data to be transmitted is transmitted in parallel via the wireless connection and the port connection.

20. The measuring system according to claim 17, in which the communication unit of the unit and the communication unit of at least one or each adapter are each designed to communicate via the wireless connection(s) between the unit and in each case one of these adapters in two or more different transmission modes differing in their carrier frequencies.

21. A measuring system according to claim 20, in which
the communication in the individual transmission modes each takes place in a different sub-range of a frequency range available for communication via the respective wireless connection, and/or
a frequency range available for communication via the respective wireless connection is subdivided into a plurality of channels (c1, . . . , c6) each having a predetermined bandwidth, and for each transmission mode a different, in particular a non-overlapping, subset (c1, . . . , c3; c4, . . . , c6) of the channels (c1, . . . , c6) is used for communication in accordance with the respective transmission mode.

22. The measuring system according to claim 21, in which
the communication unit of the unit and the communication unit of at least one or each adapter are each designed to communicate via the wireless connection(s) between the unit and in each case one of these adapters in such a manner that validation data, in particular parity data or handshake data, are transmitted via one of the transmission types, on the basis of which the authenticity and/or the consistency of data transmitted in parallel thereto via another transmission type can be checked and/or is checked, and/or
the measuring system is designed with respect to the at least one or each field device in each case to carry out the communication via the wireless connection between the respective field device and the unit in accordance with a wireless mode which can be selected from a plurality of predetermined wireless modes by a corresponding configuration of the measuring system for the respective field device, the wireless modes for each field device in each case:
comprise a basic wireless mode in which communication takes place via one of the transmission modes and is switched to another transmission mode in the event of a fault or failure of the respective transmission mode,
comprise a priority wireless mode in which one of the transmission modes is used as the primary transmission mode over which the communication between the field device and the unit takes place, and a transmission mode other than the primary transmission mode is used as the secondary transmission mode over which emergency information and/or diagnostic results issued by the field device are transmitted and/or to which the communication over the wireless connection between the unit and the respective field device is switched in the event of a fault or failure of the communication over the primary transmission mode, and/or
comprise at least one security wireless mode in which data to be transmitted via the respective wireless connection is transmitted in parallel in at least two different transmission modes.

23. The measuring system according to claim 17, wherein the unit comprises a monitoring unit designed:
for the, at least one or each field device to be connected or connected to the unit, to determine in each case whether the respective field device is connected to the unit via the associated wireless connection and/or the associated port connection and to provide information about this,
to determine the signal strength of the respective wireless connection for each field device connected to the unit via the associated wireless connection and to provide information about this,
for the, at least one or each field device connected to the unit to monitor in each case a connection quality of the associated wireless connection and/or the associated port connection, and to detect a fault or a failure of the respective connection if the connection quality falls below a limit value predetermined for this purpose, and/or
for the, at least one, or each field device communicating with the unit in two or more transmission modes via the associated wireless connection, to monitor a connection quality of the connection via at least one or each transmission mode, and to detect a fault or a failure of the connection via the respective transmission mode if the associated connection quality falls below a predetermined limit value for this purpose.

24. The measuring system according to claim 23, in which the unit is designed to switch the communication running via one of the connections monitored by the monitoring unit to another connection in the event of a fault detected by the monitoring unit or a failure of the respective connection detected by the monitoring unit, the unit particularly designed:
to switch the field device communicating with everyone in basic mode with the unit in the event of a fault or failure of the associated wireless connection and/or to switch to the associated port connection in the event of a fault or failure of the associated port connection,
to switch communication with each field device communicating with the unit in priority mode to the secondary connection in the event of a fault or failure of the primary connection,
to switch the communication with each field device communicating with the unit in basic wireless mode to another transmission mode in the event of a fault or failure of the connection via one of the transmission modes, and/or
to switch the communication with each field device communicating with the unit in priority wireless mode to the connection via the secondary transmission mode in the event of a fault or failure of the connection via the primary transmission mode.

25. The measuring system according to 24, wherein the unit comprises a test unit which is designed to perform a data integrity test using data transmitted in parallel in two or more different manners to the unit and to determine and provide an integrity test result by means of the data integrity test and/or to issue a corresponding warning and/or trigger an alarm in the event of an impairment of the data integrity determined by the data integrity test,
wherein the data transmitted in parallel to the unit in two or more different manners comprise, in particular, data transmitted via one of the wireless connections and, in parallel thereto, data transmitted via one of the port connections, and/or comprise data transmitted in parallel via one of the wireless connections in two or more transmission manners.

26. The measuring system according to claim 25, in which:
each adapter comprises a repeater which is designed to forward incoming data via the wireless interface of the respective adapter to the wireless interface of at least one other adapter and/or the wireless interface of the unit, and/or
the communication units of the adapters and the communication unit of the unit are designed as network nodes that can be connected to a wireless network via the wireless interfaces connected to them,
wherein the wireless network:
has a network architecture, a grid-shaped network architecture, or a star-shaped network architecture,
is designed to transmit data to be sent from one network node to another network node via at least two different transmission paths,
is designed in such a manner that a wireless connection can be established via the wireless network between the unit and the adapter of at least one field device located outside the wireless range of the unit, and/or
is designed to transmit data to be sent from one of the network nodes to another network node via at least two different transmission paths.

27. The measuring system according to claim 26, with a second unit to which the at least one or each field device that can be connected or is connected to the unit can be connected or is connected, wherein:
the second unit is designed as a redundant unit which can be operated either permanently in parallel with the unit and/or takes over the function of the unit in the event of a fault or failure of the unit,
and/or in which:
one of the two units is designed as a transmitter which transmits data received from at least one or each field device connected to the transmitter via a connection between the unit and the second unit, in particular a connection running via the wireless interfaces of the two units or a connection running via the module interfaces of the two units, to the other unit, and
the other unit is designed as a receiver which receives the data transmitted by the transmitter, and comprises a test unit which is designed to perform a data integrity test on the basis of at least one field device connected to both units both via the wireless connection and/or the port connection between the field device and the receiver and in parallel via the connection received from the transmitter,
wherein the test unit is designed to determine and make available a test result of the data integrity test and/or is designed to output a corresponding warning and/or trigger an alarm in the event of an impairment of data integrity determined by the data integrity test.

28. The measuring system according to claim 27, in which each adapter comprises a respective lighting apparatus with at least one lighting means, in particular a light-emitting diode or a light-emitting diode ring, for displaying at least one diagnostic result determined by the field device connected to the respective adapter and/or the unit for the field device connected to the respective adapter.

29. The measuring system according to claim 28, in which:
the gateway module or at least one of the gateway modules of the or each unit is designed in each case as a replaceable component, as a plug-in slot of the unit or as an expansion card which can be plugged into and/or connected to the unit,
which comprises at least one or each unit with two or more gateway modules communicating according to a different module-specific communication protocol, with gateway interfaces connected thereto, and/or at least one further communication module with a module interface connected thereto, in particular an Ethernet module with an Ethernet interface and/or a wireless module with a wireless interface, and is designed to communicate via the respective module interface with a correspondingly designed communication partner, in particular a operating device, a further unit, an Internet platform, and/or a database.

30. The measuring system according to claim 29, with a operating device that:
comprises a user interface with display and input means, a data processing unit, an operating software (app) which is stored in a memory of the operating device and can be executed by means of the data processing unit, and a communication unit which is connected to the data processing unit, communicates in accordance with the system protocol and has a wireless interface connected thereto,
is designed to communicate with each field device connected to the adapter via a wireless connection between the wireless interface of the operating device and the wireless interface of the adapter using its communication unit and each unit connected to the operating device via a wireless connection between the wireless interface of the operating device and the wireless interface of the unit in accordance with the system protocol, and
the operating software (app) of which is designed to provide a user of the operating device with a user interface via which the measuring system can be operated.

31. The measuring system according to claim 30, in which the operating device:
is designed to identify each field device connected to one of the adapters and/or each unit connected to one of the adapters, to read out from each field device a field device identifier stored in the respective field device and/or to display it directly and/or on request via the user interface, and/or to read out from each unit and/or display it via the user interface immediately and/or on request,
comprises a positioning unit which is designed to locate field devices connectable or connected to the operating device via the adapter connected thereto and/or units connectable or connected to the operating device and to display and/or otherwise make available their location directly or at the request of the user via the user interface, and/or
at least one further communication module with a module interface, in particular an Ethernet module with an Ethernet interface and/or a wireless module with a wireless interface, and is designed to communicate with the or each unit, an Internet platform, and/or a database via the module interface.

32. The measuring system according to claim 31, in which:
the operation:
comprises identification, location, configuration, parameterization, and/or modification of the configuration and/or parameterization of at least one or each field device connected to one of the adapters,
comprises configuring and/or changing the configuration of at least one or each lighting apparatus, and/or
comprises identification, location, configuration, parameterization, and/or modification of the configuration and/or parameterization of at least one or each unit,
the operating device is designed to display information to the user, wherein the information comprises measured values of the measured variable(s), diagnostic results for at least one of the field devices, for each field device, the communication mode and/or the wireless mode in accordance with which the unit communicates with the respective field device, information that can be determined by means of the monitoring unit and/or the test unit of the unit, and/or information retrievable from an Internet platform or a database, in particular technical information, operating instructions, certificates, and/or explanatory videos for each unit and/or each field device, and/or
the user interface is designed as a menu-based interface, wherein the menu comprises a system level, a unit level for each unit and a field device level for each field device, wherein the menu is designed in particular such that at the system level each unit is linked via a link to the associated unit level, at each unit level the field devices connected to the unit are each linked via a link to the associated unit level, and the user is offered a sub-menu, via the sub-menu items of which the user can carry out and/or change the configuration and/or parameterization of the unit, and/or a sub-men is displayed to the user at each field device level via the sub-menu items of which the user can carry out and/or change the configuration and/or parameterization of the field device and/or the configuration of the lighting apparatus of the adapter connected to the field device.
